(19) United States
(12) Patent Application Publication
(10) Pub. No.: US 2004/0103923 A1
(43) Pub. Date: Jun. 3, 2004

(54) AUTOMATED CONVEYOR BELT TREATMENT SYSTEM

(75) Inventor: Christopher Brink, Hamilton, OH (US)

Correspondence Address: S.C. JOHNSON COMMERCIAL MARKETS INC, 8310 16TH STREET, M/S 510, PO BOX 902, STURTEVANT, WI, 53177-0902, US

(73) Assignee: JOHNSONDIVERSEY, INC., Sturtevant, WI (US)

(21) Appl. No.: 10/605,662

(22) Filed: Oct. 16, 2003

Related U.S. Application Data
(60) Provisional application No. 60/418,960, filed on Oct. 16, 2002.

(51) Int. Cl. B08B 3/00; B08B 1/02

(52) U.S. Cl. 134/26; 134/15; 134/32; 134/34; 134/61; 134/64 R; 134/122 R

(57) ABSTRACT

A treatment system for use with conveyor apparatus that allows for the uninterrupted use of the conveyor apparatus system while simultaneously treating the conveyor belt. The system employs of a sump basin and various spray bars that can sanitize, clean or lubricate a conveyor belt in conjunction with the processing of various products. The treatment system allows for the effective reduction of the down time in the manufacturing possess using conveyor apparatus.

### CROSS REFERENCE TO RELATED APPLICATIONS

This application is a formal application which claims priority of U.S. Serial No. 60/148,960, filed Oct. 15, 2002.

### BACKGROUND OF INVENTION

1. Field of the Invention

The field of the invention is a treatment system for a conveyor apparatus used in manufacturing environments and the method of applying a solution to a rotating conveyor belt. The invention discloses an apparatus which simultaneously treats the conveyor belt while processing products.

2. Background

The protection of products from contamination during use of conveyor apparatus have plagued the manufacturing industry. The current invention solves the dilemma of having to shut the system down to treat the system with a sanitizer, a washing solution or a lubricant between product runs. The present invention treats the conveyor belt during the part of the system when the conveyor belt contains no products and is returning to the beginning of the production line to pick up the next batch of products. The invention allows for the continuous running of the conveyor belt while still providing proper conditions.

The issue of sanitized production conditions is most prevalent in the food manufacturing industry in which any contamination of the product can harm the health of the end user of the product. The current system would safeguard the food manufacturing industry from any contamination of product or cross-contamination of separate products run on a single conveyor belt. The invention further includes a method in which a sanitizer is constantly diluted, dispensed, and applied to a conveyor belt sanitizing the conveyor belt surface for contact with product which allows for constant production runs which eliminate costly shut-downs for sanitizing purposes.

The invention further allows for the use of a cleaning solution, a sanitizer and/or application of a lubricant alone or in any combination in the various steps of the treatment process. The invention solves the two main problems of the existing technology in which there is the use of brushes that can slow a line or stop a line and can damage the conveyor belt itself or require the shutting down of the line in order to treat the conveyor belt. The current invention uses a wash spray bar to effectively clean the conveyor belt as it is passed through the solution of the sump basin that allows for the effective cleaning or sanitizing of the conveyor belt while not interrupting the line.

U.S. Pat. No. 5,649,616 discloses a conveyor belt washing system in which the conveyor belt is continuously cleaned during use. The aforementioned patent diverts the conveyor belt through a series of brushes to clean the conveyor belt during processing in order to properly clean the conveyor belt.

U.S. Pat. No. 3,998,321 discloses a conveyor belt system that uses wash rollers and a fluid wash basin to clean the conveyor belt. The '321 patent uses wash rollers in contact with the top surface of the conveyor belt prior and after the conveyor belt is passed through the wash basin to clean the conveyor belt effectively.

### SUMMARY OF INVENTION

The treatment system utilizes the continuous rotation of the conveyor belt to apply a lubricating, cleaning and/or sanitizing process.

As the conveyor belt travels to the end of the frame, it travels under the conveyor apparatus frame and into the treatment system.

As the conveyor belt enters the system, the product contact surface is positioned face down. Inside the system is a cascading sump basin of residual solution, here the conveyor belt is submerged for an initial rinse. As the conveyor belt moves through the sump it travels between at least one recirculating wash spray bars. The preferred embodiment has two wash spray bars a top bar floods the underside of the conveyor belt; the bottom bar rinses the topside surface of the conveyor belt. Once the conveyor belt leaves the recirculating spray bars it is moved to a vertical position and passed in front of a rinse spray bar. This spray bar is not only used to spray the sanitizer on the topside of the conveyor belt which is the product contact area, but also may be used for application of a lubricant or other treatment product. As the conveyor belt leaves the treatment system, it allows the sanitizer or lubricant the proper drying and contact time to achieve its purpose. This extended time not only allows the chemistry to work longer, it also allows the process to use a lower concentration of product such as the sanitizer. The system also incorporates a system check function which allows the monitoring and recording of treatment use and function. The check system further allows for the automatic stopping and starting of the treatment system directly relating to the conveyor belts operation.

The ultimate goal of the sanitation process disclosed in this invention is to combine the product manufacturing process with the treatment process providing for an efficient, safe, and sanitary production process and final product.

### BRIEF DESCRIPTION OF DRAWINGS

FIG. 1 a side view showing the components of the treatment system in conjunction with the conveyor apparatus.

FIG. 2 a side view of the treatment system integrating with the conveyor belt.

FIG. 3 a side view of the treatment system integrating with the conveyor belt with multiple rinse spray bars.

FIG. 4 a top view of the treatment system with the conveyor belt engaged and the sump basin shown in phantom.

FIG. 5 a top view of the conveyor belt system with the treatment system show in a cut away.

### DETAILED DESCRIPTION

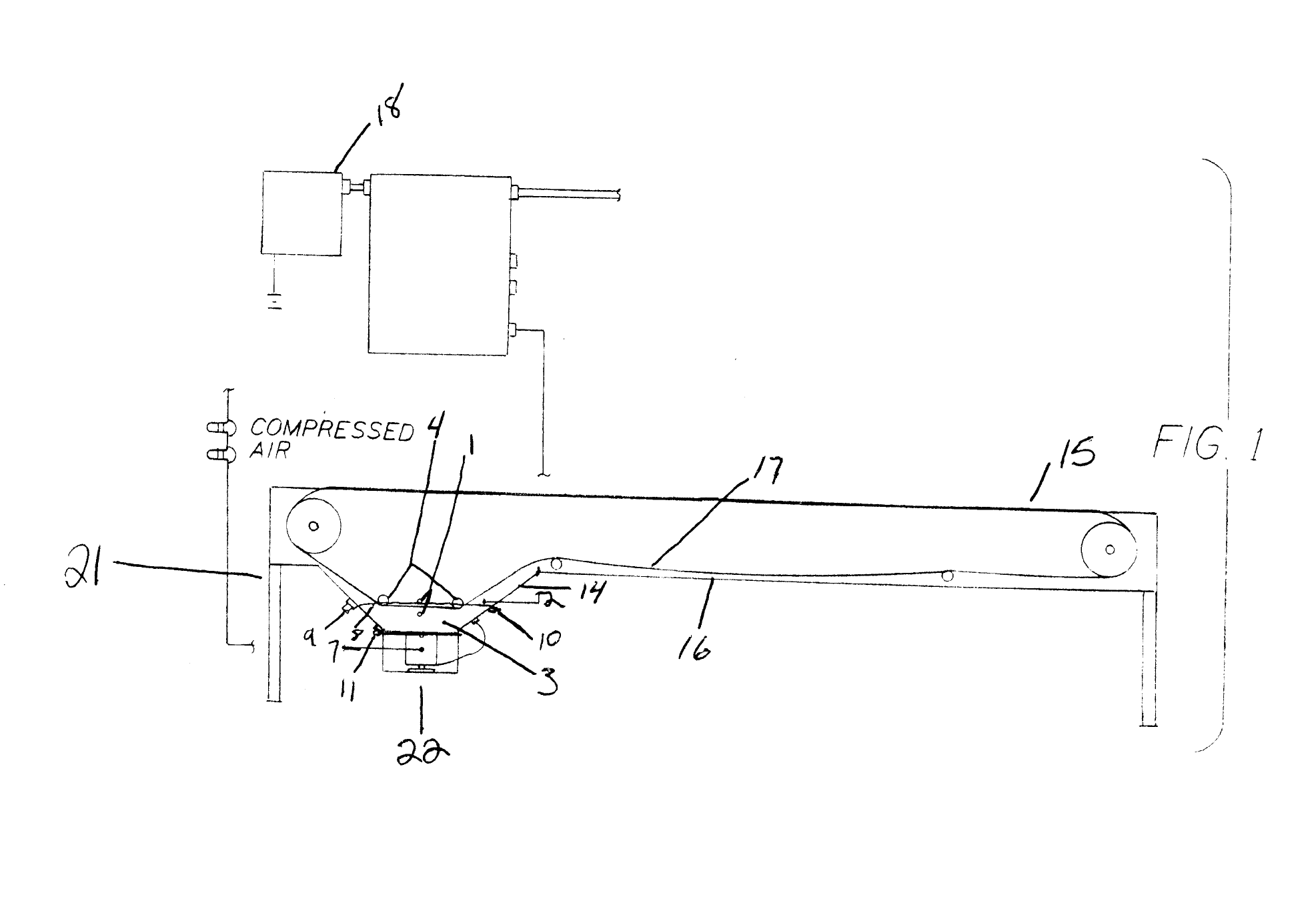

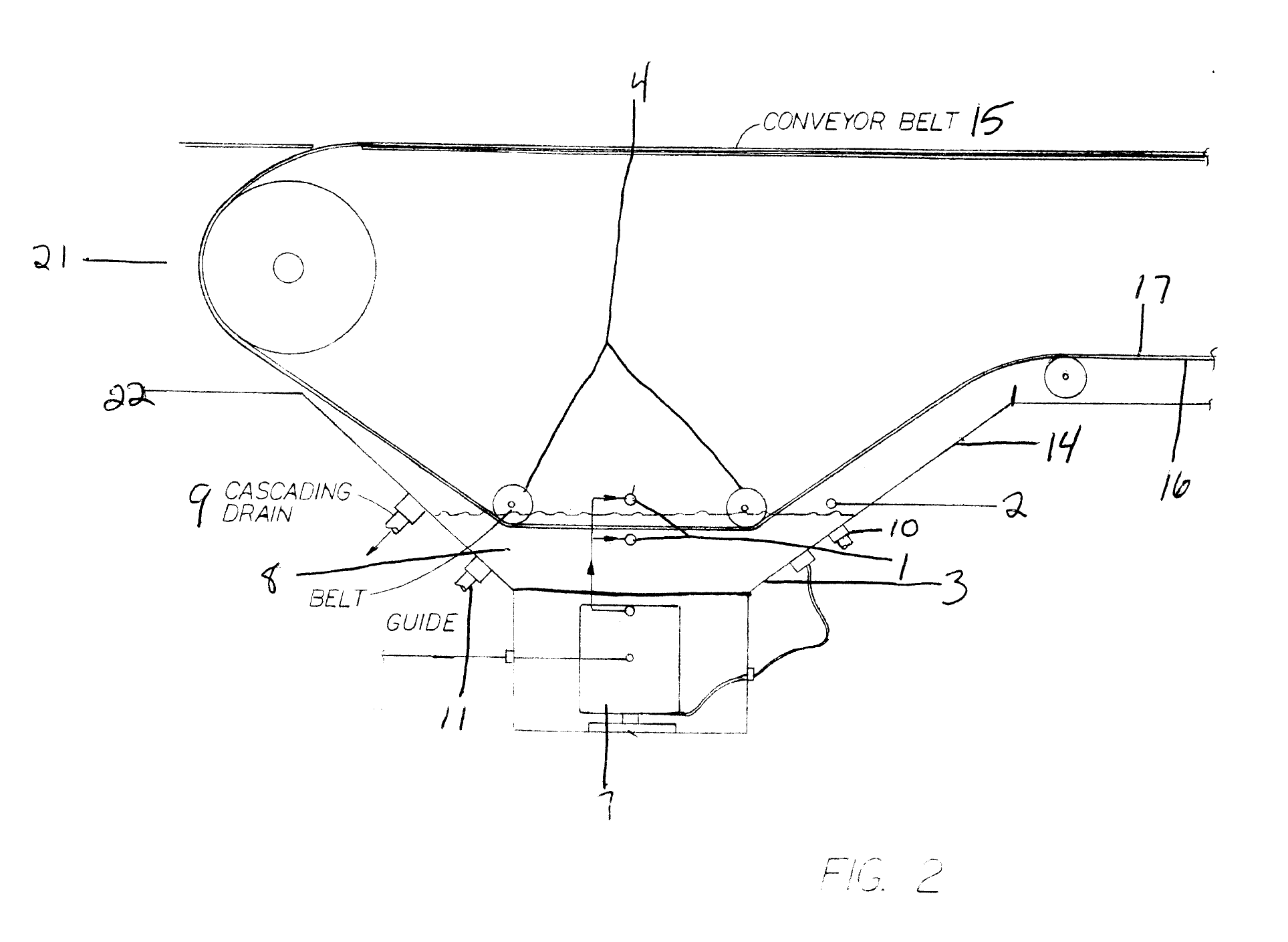

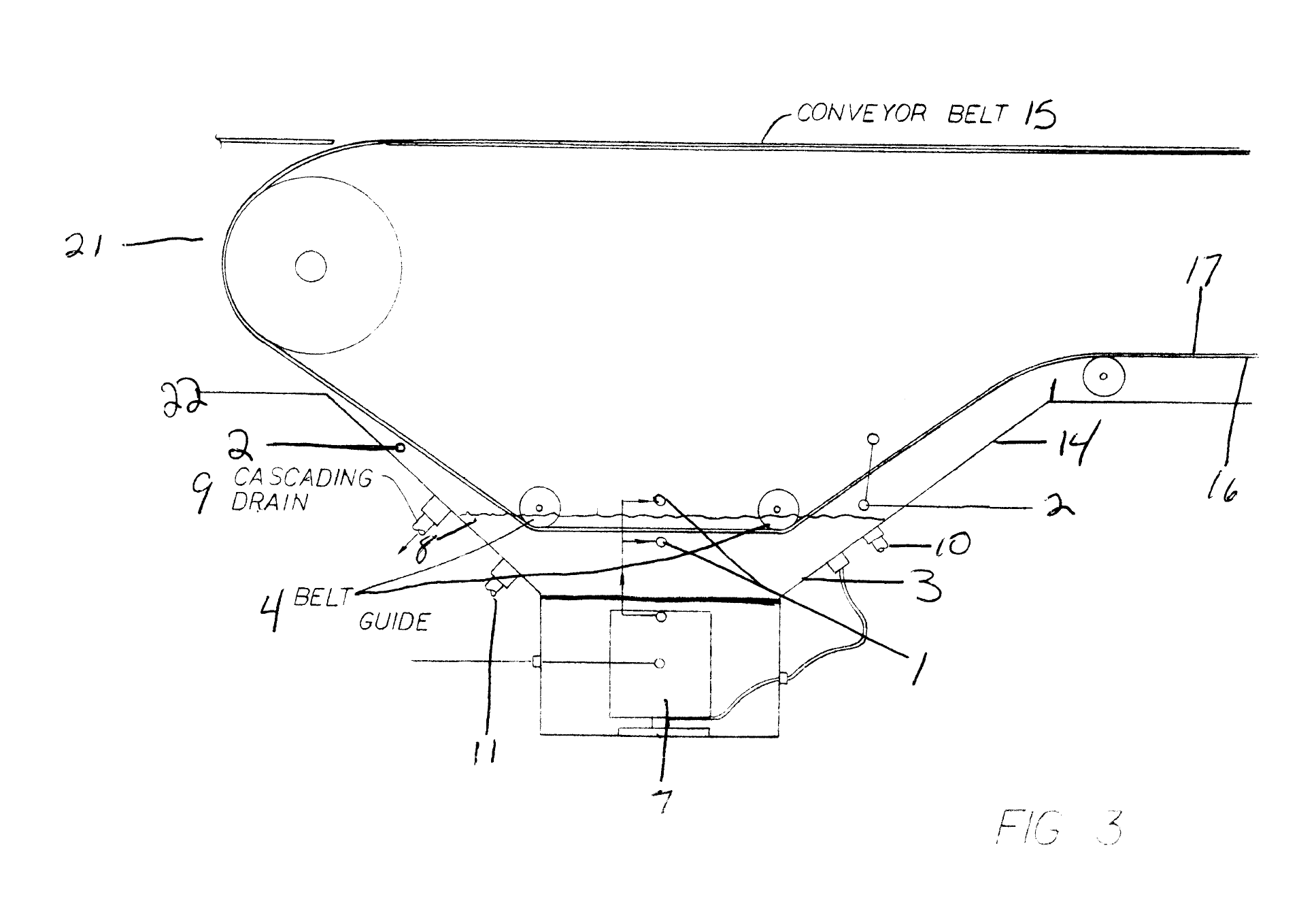

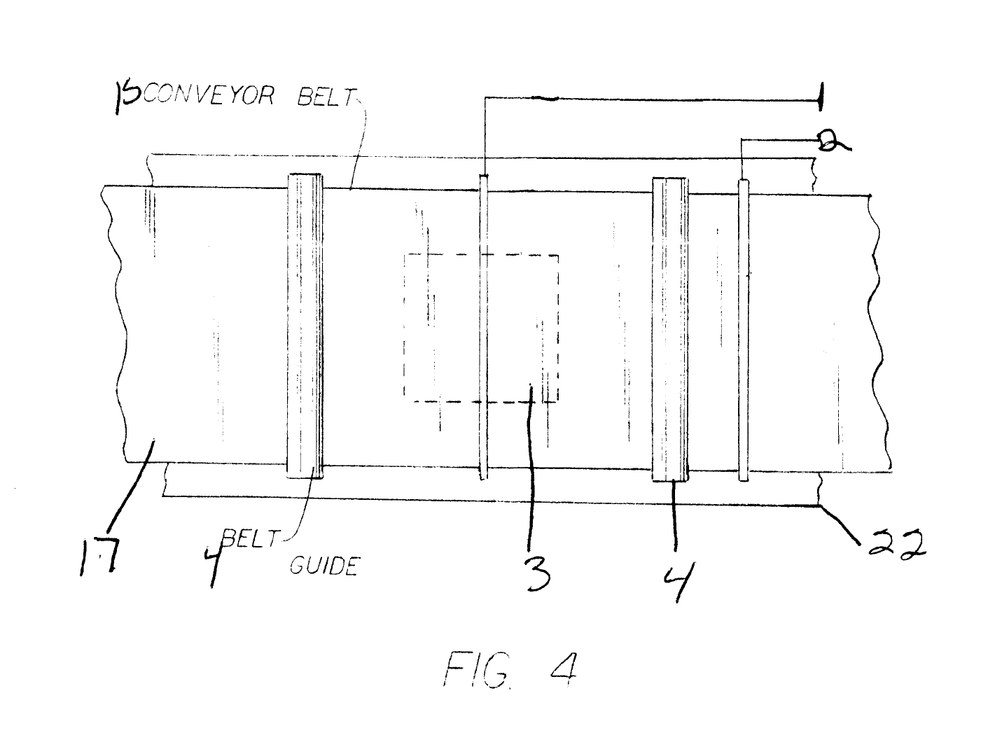

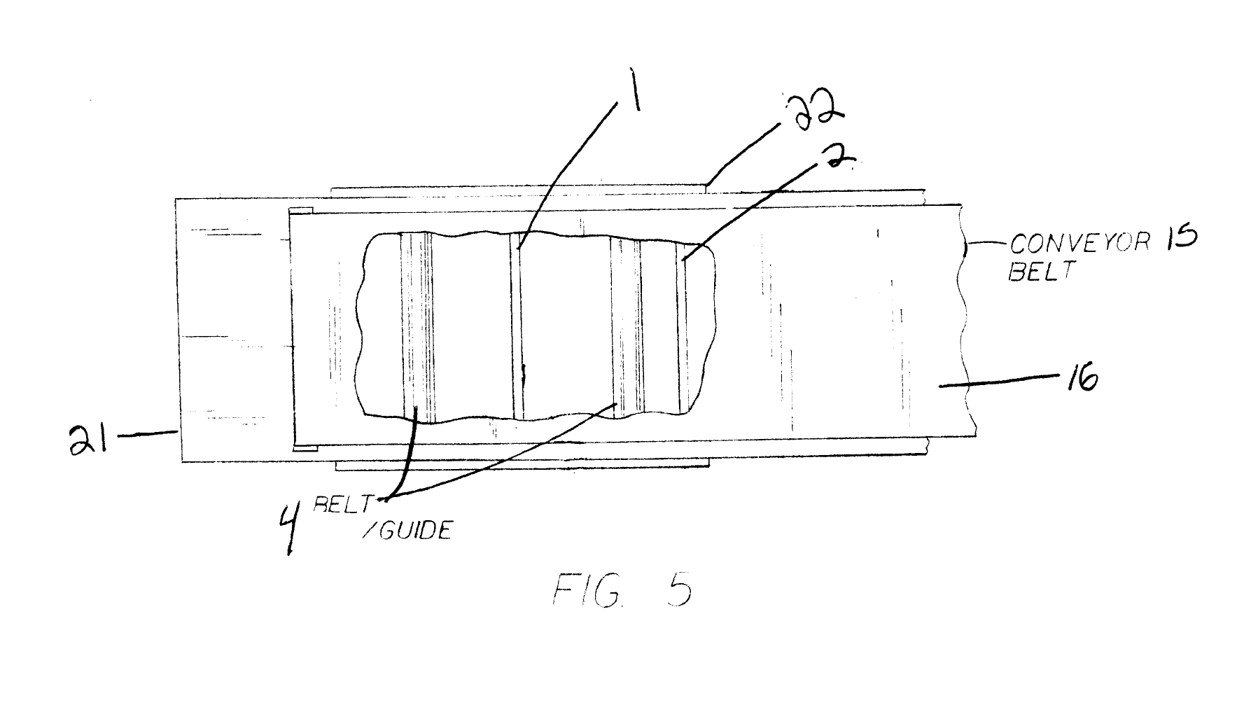

Referring to FIGS. 1-5, one embodiment of the treatment system generally 22 is system for treatment of a conveyor apparatus generally 21 comprised of a sump basin 3 containing a solution 8. The solution 8 is in the sump basin 3 at a level to submerse a portion of a conveyor belt 15. The conveyor apparatus 21 has the treatment system 22 attached to it and the conveyor belt 15 is guided by at least one conveyor belt guide 4 into the treatment system 22. Once the conveyor belt 15 is engaged with the treatment system 22 the conveyor belt 15 enters the sump basin 3 containing a solution 8 there is at least one wash spray bar 1 submersed below the solution 8.

Additional embodiments may further include one or more of the following items. The invention may include a circulation pump 7 that is located below the sump basin 3 and regulates the amount and flow of the solution in the sump basin 3. The invention may include one or more rinse spray bars 2 which can be located prior to the wash rinse bars 1 or after the wash rinse bars 1. The invention also may include a cascade drain keeps the solution 8 level consistent in the sump basin and/or a skimmer drain 10 which allows for debris from the conveyor belt 15 which is floating to be removed with out having to empty the entire sump basin 3 and/or a drain 11 which is located in the lower section of the sump basin 3 allowing for the complete draining of the solution 8 from the sump basin 3. The invention may further include a shedding pan 14 which is connected to the sump basin, collects, and returns any excess solution 8 on the conveyor belt 15 to be returned to the sump basin 3.

The invention allows for the use of various solutions with the treatment system including, but not limited to, sanitizers, washing compositions and lubricants. The solution 8 in the sump basin and the solutions from the rinse bars may be the same solution or may be different solutions for various applications and purposes including the application of lubricants. In addition, the solution that is emitted from the wash spray bar 1 may be drawn from the solution 8 in the sump basin.

The invention in addition to all the other features includes two or more wash spray bars 1 at least one submersed below the solution which sprays the topside 16 of the conveyor belt 15 and at least one wash spray bar 1 above the solution which sprays the underside 17 of the conveyer as it passes through the solution 8. The invention may also have multiple rinse spray bars 2 that can be located below the conveyor belt 15 to spray the topside 16 of the conveyor belt 15 and/or located above the conveyor belt 15 to spray the underside 17 of the conveyer 15. The rinse spray bars 2 and the wash spray bars 1 can be in of varying length and size but must emit enough of whatever solution and cover enough surface area to reach all of the surface area of the conveyor belt 15.

As seen in FIG. 1, the invention may further include a standard monitoring system 18 wherein the monitoring system 18 starts and stops the treatment system 22 at required intervals to limit unnecessary excess treatment. The monitoring system 22 can also track and control solution 8 levels in the sump basin 3 and amount of solutions to be emitted from the wash 1 and rinse spray bars 2.

The invention includes a method of cleaning a conveyor belt 15 wherein once the conveyor belt 15 is free of any product it is diverted into a treatment system 22 comprised of a sump basin 3 containing a solution 8 and at least one wash spray bar 1 which is submersed in the solution 8 and sprays the conveyor belt 15 as it passes through the sump basin 3.

The method also includes placing at least one wash spray bar submersed in the solution and spraying the topside of the conveyor belt as it passes through the sump basin solution and at least one wash spray bar above the solution and spraying the underside of the conveyor belt 15 as it passes through the sump basin solution. The method further including a rinse spray bar 2 wherein after the conveyor belt 15 leaves the sump basin 3 solution 8 there is at least one rinse spray bar 2 that emits a solution to the conveyor belt 15. The method where there is at least one rinse spray bar 2 positioned to emit a solution to the top side 16 of the conveyor belt 15 and at least one rinse spray bar 2 positioned to emit a solution on the underside 17 of the conveyor belt 15 as the conveyor belt 15 exits the sump basin 3 solution 8. The method further including at least one rinse spray bar 2 prior to the sump basin 3 to rinse the conveyor belt 15.

1. A system for treatment of a conveyor belt comprising: a sump basin containing a solution at a level to submerse a portion of a conveyor belt, at least one conveyor belt guide and at least one wash spray bar submersed below the solution.

2. The system of claim 1 further including a circulation pump.

3. The system of claim 2 wherein there is at least one rinse spray bar.

4. The system of claim 3 wherein the sump basin includes a cascade drain.

5. The system of claim 3 wherein the sump basin includes a skimmer drain at the solution level to allow the purging of any floating debris.

6. The system of claim 3 wherein the sump basin includes a drain in proximity to the bottom of the sump basin.

7. The system of claim 3 wherein a shedding pan is connected to the sump basin.

8. The system of claim 7 wherein the shedding pan collects and returns all excess solution from the conveyor belt into sump basin.

9. The system of claim 1 wherein the solution is a lubricant, a washing solution or a sanitizing solution.

10. The system of claim 1 wherein there at least two wash spray bars one submersed below the solution which sprays the topside of the conveyor belt and a wash spray bar above the solution which sprays the underside of the conveyer as it passes through the solution.

11. The system of claim 3 wherein at least one rinse spray bar is rinsing the conveyor belt after it leaves the solution.

12. The system of claim 3 wherein there are two rinse spray bars, one spray bar rinsing the topside of the conveyor belt prior to it entering the solution and one spray bar rinsing the top side of the conveyor belt after it leaves the solution.

13. The system of claim 3 wherein there are two rinse spray bars, one rinsing the topside of the conveyor belt and the other rinsing the underside of the conveyor belt prior to the conveyor belt entering the solution and two rinse spray bars one rinsing the topside of the conveyor belt and the other rinsing the underside of the conveyor belt after the conveyor belt leaves the solution.

14. The system of claim 3 wherein the solution in the in the sump basin and the solution emitted from the rinse and wash spray bars is a sanitizing solution.

15. The system of claim 3 wherein the solution in the sump basin and the solution emitted from the wash spray bar is the same solution.

16. The system of claim 15 wherein the solution emitted from the rinse spray bar is not the same as the solution in the sump basin.

17. The system of claim 16 where in the solution emitted from the wash bar draws the solution from the sump basin.

18. The system of claim 3 where in the wash and rinse spray bars are of a size so that enough solution is emitted to saturate the width of the conveyer.

19. The system of claim 11 where in the rinse spray bar is emitting a lubricant onto the conveyor belt.

20. The system of claim 17 where in the solution in the sump basin and emitted from the wash spray bars is a washing solution and the solution emitted from the rinse spray bars is a sanitizing solution.

21. The system claim 3 comprising a monitoring system to track the systems use.

22. The system of claim 21 wherein the monitoring system starts and stops the system at required intervals allowing for the use only when needed.

23. The system of claim 21 wherein the monitoring system controls solution levels in the sump basin and the spray amount from the wash and rinse spray bars.

24. A method of cleaning a conveyor belt wherein once the conveyor belt is free of any product it is diverted into a treatment system comprised of a sump basin containing a solution and at least one wash spray bar which is submersed in the solution and sprays the conveyor belt as it passes through the sump basin.

25. The method of claim 24 wherein there is at least one wash spray bar submersed in the solution and sprays the topside of the conveyor belt as it passes through the sump basin solution and at least one wash spray bar above the solution and sprays the underside of the conveyor belt as it passes through the sump basin solution.

26. The method of claim 24 wherein after the conveyor belt leaves the sump basin solution there is at least one rinse spray bar that emits a solution to the conveyor belt.

27. The method of claim 26 wherein there is at least one rinse spray bar positioned to emit a solution to the top side of the conveyor belt and at least one rinse spray bar positioned to emit a solution on the underside of the conveyor belt as the conveyor belt exits the sump basin solution.

28. The method of claim 24 wherein before the conveyor belt enters the sump basin solution there is at least one rinse spray bar that emits a solution to the conveyor belt.

29. The method of claim 26 wherein there is at least one rinse spray bar positioned to emit a solution to the top side of the conveyor belt and at least one rinse spray bar positioned to emit a solution on the underside of the conveyor belt as the conveyor belt enters the sump basin solution.
